(19) United States
(12) Patent Application Publication
(10) Pub. No.: US 2010/0076832 A1
(43) Pub. Date: Mar. 25, 2010

(54) VIRTUAL COUPON SERVICE SYSTEM

(75) Inventor: Suk-kyoung Cha, Seoul (KR)

Correspondence Address: North Star Intellectual Property Law, PC, P.O. Box 34688, Washington DC, DC, 20043, US

(73) Assignee: SHARP KABUSHIKI KAISHI, OSAKA-SHI OSAKA (JP)

(21) Appl. No.: 12/447,880

(22) PCT Filed: Nov. 5, 2007
(86) PCT No.: PCT/KR07/05547

§ 371 Date: Apr. 29, 2009

(51) Int. Cl. G06Q 30/00; G01C 21/00

(52) U.S. Cl. 705/14.25; 701/300; 705/14.26; 705/14.36; 705/14.38

(57) ABSTRACT

A virtual coupon service system is provided. The virtual coupon service system includes: an information acquiring unit acquiring member identification information of a member who wants to purchase a product for which the coupon is valid, and coupon information regarding the product; an information registering unit mapping the member identification information to the coupon information, and registering the result of the mapping; a coupon service providing unit acquiring the member identification information and a product code of the product, determining whether the member identification information is registered with the information registering unit, determining whether at least one coupon information mapped to the member identification information is associated with the product code, if the member identification information is registered in the information registering unit, providing a coupon service if the at least one coupon information includes the product code.

### TECHNICAL FIELD

The present invention relates to a coupon service.

### BACKGROUND ART

Paper coupons that can be used when purchasing goods are distributed through daily newspapers or magazines, through the Internet, or by keeping them in stores. However, it is inconvenient for users to carry paper coupons with them, and it is difficult to collect paper coupons and reflect the actual condition of paper coupon use to marketing strategies because they are distributed at random. In order to resolve the problems, an electronic coupon service has been proposed. The electronic coupon service distributes electronic coupons to users through a network such as the Internet, and allows the users to store the electronic coupons in their cellular phones and display the electronic coupons on the screens of their cellular phones when they purchase goods for which the electronic coupons are valid. Also, in the electronic coupon service, by distributing electronic coupons only to members which satisfy a specific condition, the actual condition of the coupon use can be reflected to marketing strategies to plan sales promotion.

However, in the electronic coupon service, electronic coupon data has to be stored in a user's cellular phone and occupies a storage space in the cellular phone. Also, it is inconvenient for the user to search a memory of the cellular phone for an electronic coupon which he or she wants to use in order to display the electronic coupon on the screen of the cellular phone.

### DISCLOSURE OF INVENTION

### Technical Solution

The present invention provides a virtual coupon service system which allows a user to use a coupon service without distributing an actual coupon.

### Advantageous Effects

A virtual coupon service system according to the present invention can obtain the same effect as distributing an actual coupon by assigning a virtual coupon to a user. Therefore, the user needs not to carry a coupon, and can easily search for and display a desired coupon from among electronic coupons stored in his or her portable terminal to use the coupon.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a virtual coupon service system according to an embodiment of the present invention;

FIG. 2 is a block diagram of a virtual coupon service system according to another embodiment of the present invention;

FIG. 3 is a block diagram of a virtual coupon service system according to still another embodiment of the present invention;

FIG. 4 illustrates an example where the virtual coupon service system illustrated in FIG. 2 is executed; and

FIG. 5 illustrates an example where the virtual coupon service system illustrated in FIG. 3 is executed.

### BEST MODE FOR CARRYING OUT THE INVENTION

According to an aspect of the present invention, there is provided a virtual coupon service system including: an information acquiring unit acquiring member identification information of a member who wants to purchase a product for which a coupon is valid, and coupon information regarding the product; an information registering unit mapping the member identification information to the coupon information, and registering the result of the mapping; a coupon service providing unit acquiring the member identification information and a product code of the product, determining whether the member identification information is registered with the information registering unit, determining whether at least one coupon information mapped to the member identification information is associated with the product code, if the member identification information is registered with the information registering unit, providing a coupon service if the at least one coupon information includes the product code.

Additional features of the invention will be set forth in the description which follows, and in part will be apparent from the description, or may be learned by practice of the invention.

### Mode for the Invention

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

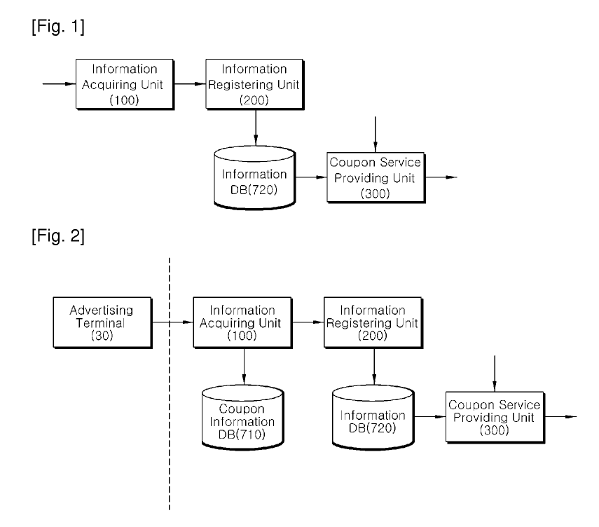

FIG. 1 is a block diagram of a virtual coupon service system according to an embodiment of the present invention.

Referring to FIG. 1, the virtual coupon service system includes an information acquiring unit 100, an information registering unit 200, an information database 720, and a coupon service providing unit 300. The information acquiring unit 100 acquires identification information of a member who wants to purchase a product for which a coupon is valid. Also, the information acquiring unit 100 acquires coupon information regarding the product. Here, the coupon information may include the name of the product, a rate of discount, or a mileage. The coupon information may further include a validity date. The product for which the coupon is valid represents a product on which a purchaser gets a discount or a mileage by using the coupon when purchasing the product. An embodiment in which the information acquiring unit 100 acquires the member identification information and the coupon information will be described later.

The information registering unit 200 maps the member identification information to the coupon information, and registers the result of the mapping. The information database 720 stores the member identification information and the coupon information which are mapped to each other. The member identification information may include one or more pieces of coupon information.

When a member purchases a product, the coupon service providing unit 300 acquires identification information of the member, and determines whether the member identification information is stored in the information database 720. If the member identification information is stored in the information database 720, the coupon service providing unit 300 determines whether at least one purchasable product code exists among one or more pieces of coupon information mapped to the member identification information. If at least one purchasable product code exists, the coupon service providing unit 300 provides a coupon service to the member. Here, the coupon service includes getting a discount for the product which the member wants to purchase, and accumulating a mileage. Therefore, the coupon service providing unit 300 checks the coupon information, and provides a coupon service of providing a discount for the product which the member wants to purchase or of accumulating a mileage, according to the coupon information, if the period of validity of the coupon does not expire.

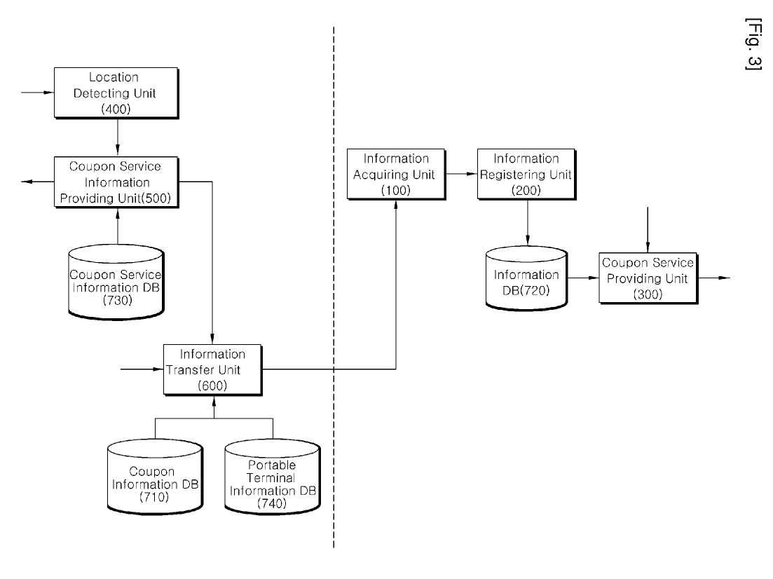

FIG. 2 is a block diagram of a virtual coupon service system according to another embodiment of the present invention.

The virtual coupon service system illustrated in FIG. 2 has the same construction as that of the virtual coupon service system illustrated in FIG. 1, except for further including an advertising terminal 30. In the virtual coupon service system illustrated in FIG. 2, an information acquiring unit 100 acquires identification information of a member and coupon information through the advertising terminal 30.

The advertising terminal 30 includes a display unit (not shown) for displaying images or a voice output unit (not shown) for outputting voices. The advertising terminal 30 provides coupon service information regarding a product for which a coupon is valid, through a screen of the display unit and/or through the voice output unit. Also, the advertising terminal 30 acquires identification information of a member which wants to get a coupon for the product. The advertising terminal 30 may acquire the member identification information through a membership card including a smart chip in which the member identification information is stored. For example, the member identification information may be the ID of a smart chip included in a membership card. The smart chip can function as a credit card, a membership card, and/or a traffic card. The smart chip is provided only to members that subscribe to the virtual coupon service.

The advertising terminal 30 may acquire the member identification information from a portable terminal storing the member identification information. The portable terminal may be a communication terminal such as a cellular phone or a personal digital assistant (PDA). The member identification information may be an ID by which a portable terminal is identified. That is, a member can be identified by the ID. The ID may be the ID of a smart chip, which is included in the member identification information. The smart chip can function as a credit card, a membership card, and/or a traffic card. The smart chip is provided only to members that subscribe to the virtual coupon service. The member identification information may be RF tag information which is stored in a portable terminal, or an electronic serial number (ESN) of a portable terminal.

Meanwhile, it is preferable that the same local communication technology is applied between the advertising terminal 30 and a membership card and between the advertising terminal 30 and a portable terminal so that the advertising terminal 30 can acquire member identification information stored in the membership card or in the portable terminal. The local communication technology may be an Radio Frequency Identification (RFID) technology.

Meanwhile, the member identification information can be stored in any other devices other than a membership card or a portable terminal.

The information acquiring unit 100 receives the member identification information which is output from the advertising terminal 30. Also, the information acquiring unit 100 acquires coupon information mapped to the member identification information, for example, by identifying the advertising terminal 30. In order to acquire coupon information mapped to the member identification information, the virtual coupon service system further includes a coupon information database 710. The coupon information database 710 stores coupon information mapped to the ID of the advertising terminal 30. The information acquiring unit 100 acquires the corresponding coupon information from the coupon information database 710 by identifying the advertising terminal 30 which outputs the member identification information.

Details for the information registering unit 200, the information database 720, and the coupon service providing unit 300 illustrated in FIG. 2 have been described above with reference to FIG. 1. Meanwhile, blocks on the right side of a dotted line in FIG. 2 are components of a Point-of-Sale (POS) system. A block on the left side of the dotted line is a terminal which does not belong to the POS system but can communicate with the POS system through a communication cable or through wireless communications.

FIG. 3 is a block diagram of a virtual coupon service system according to another embodiment of the present invention. Referring to FIG. 3, the virtual coupon service system has the same construction as that of the virtual coupon service system illustrated in FIG. 2, except for further including a location detecting unit 400, a coupon service information providing unit 500, and an information transfer unit 600. The virtual coupon service system illustrated in FIG. 2 defines a method in which the information acquiring unit 100 acquires member identification information and coupon information.

The location detecting unit 400 detects where a member is located. A Global Positioning System (GPS) technology can be used to detect where a member is located. The GPS technology is well-known in the art, and accordingly, a detailed description thereof will be omitted.

The coupon service information providing unit 500 provides to a member's portable terminal coupon service information regarding purchasing of a product for which a coupon is valid, when the member's location satisfies a predetermined condition. The predetermined condition may be set to within a predetermined range from a designated store. For example, if the member is located within a radius range of 300 m from a designated store, the coupon service providing unit 500 provides to the member's portable terminal service information for a coupon which is available in the designated store.

For example, the coupon service providing unit 500 sends to the member's portable terminal a text message indicating that coupon service information exists. The text message may be sent by a Short Message Service (SMS). The text massage may include URL access information.

The member may see the coupon service information through URL access information included in the text message.

The coupon service information is stored in a coupon service information database 730. For example, a plurality of pieces of coupon service information are classified and stored according to members' genders, ages, grades, etc. Accordingly, the coupon service information providing unit 500 provides the corresponding coupon service information according to the members' genders, ages, grades, etc., to the member's portable terminal. Also, the coupon service information providing unit 500 allows the member to select his or her desired coupon, and provides the selected coupon to the member.

The member manipulates keys of his or her portable terminal to request his or her desired coupon and receive it. The coupon is not an actual coupon but a virtual coupon.

Meanwhile, the coupon service providing unit 500 may provide advertisements other than the coupon service information. That is, the coupon service providing unit 500 may provide the coupon to the member as a reward for viewing advertisements.

If a coupon service request is issued from a portable terminal, the information transfer unit 600 extracts identification information of a member corresponding to the portable terminal from a member identification information database 740, extracts coupon information from the coupon information database 710, and transfers the coupon information to the information acquiring unit 100.

The information acquiring unit 100 receives the member identification information and coupon information from the information transfer unit 600. Details for an information registering unit 200, an information database 720, and a coupon service providing unit 300 illustrated in FIG. 3 have been described above with reference to FIG. 1, and accordingly, detailed descriptions thereof will be omitted.

Meanwhile, blocks on the right side of a dotted line in FIG. 3 are components of a POS system, and blocks on the left side of the dotted line are components of a separate server which does not belong to the POS system. Accordingly, the information transfer unit 600 transmits the member identification information and coupon information to the information acquiring unit 100 through a network.

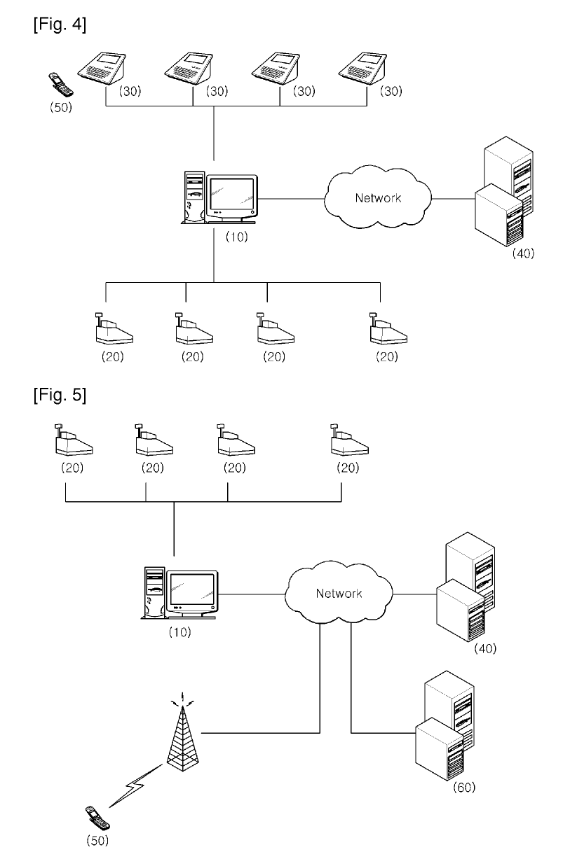

FIG. 4 illustrates an example where the virtual coupon service system illustrated in FIG. 2 is executed.

Referring to FIGS. 2 and 4, a POS server 10 communicates with a plurality of POS terminals 20 (20 for each), for example, according to the RS-232C standard. As well-known in the art, a POS server and POS terminals construct a POS system. Since the structure of such a POS system is well-known, a detailed description thereof will be omitted.

Also, the POS server 10 communicates with a plurality of advertising terminals 30 (30 for each), for example, according to the RS-232C standard. For example, the advertising terminals 30 are placed on product display counters, and provide to members coupon service information regarding products which are exhibited on the product display counters. The advertising terminals 30 may provide the coupon service information by outputting images and voices. Also, each advertising terminal 30 may provide an advertisement regarding a product which a member wants to purchase. Furthermore, the POS server 10 may communicate with the coupon service server 40 through an external network. The coupon service server 40 provides information required for the coupon service to the POS server 10.

Hereinafter, a virtual coupon service according to an embodiment of the present invention will be described in detail.

A system manager sets event information in the coupon service server 40. Here, the event information means information required to provide a coupon service regarding purchasing of a product. For example, the event information may include coupon service information, coupon information, information regarding a region in which the coupon service is provided, information regarding stores designated in a region, target members information, etc. The target members information can be created by classifying members according to their genders, ages, purchase histories, etc. Also, the target members information can be created by classifying members' grades according to their purchase histories, etc. and limiting the coupon service according to the members' grades. Accordingly, the coupon service information and the coupon information will be classified according to the members' grades. Also, it is possible to limit the coupon service according to date and time.

The coupon service server 40 transmits the coupon information, the coupon service information, and target members identification information, to a POS server 10 of a designated store indicated by the event information. The POS server 10 receives the coupon information, the coupon service information, and the target members identification information from the coupon service server 40, and stores them therein.

The POS server 10 outputs the coupon service information to an advertising terminal 30 designated by the coupon service information. For example, if the coupon service information includes “XX bathroom tissue”, the POS server 10 outputs the coupon service information to an advertising terminal 30 placed on a product display counter which exhibits the “XX bathroom tissue”. Also, the POS server 10 can output the coupon service information to the advertising terminal 30 according to the system manager's command. If the advertising terminal 30 stores product information mapped thereto, the POS server 10 outputs the coupon service information to the advertising terminal 30 by identifying the advertising terminal 30 through the product information.

Meanwhile, the advertising terminal 30 outputs the coupon service information through images and voices. The advertising terminal 30 may output the coupon service information through images and voices only when an authorized member accesses the coupon service information. To output the coupon service information only when an authorized member accesses the coupon service information, the advertising terminal 30 acquires member identification information stored in the authorized member's portable terminal 50, determines whether the member belongs to a target group to which the coupon service can be provided, and informs the member of the coupon service information only when the member belongs to the target group. The advertising terminal 30 transfers the member identification information to the POS server 10, thus determining whether the member belongs to the target group according to a response from the POS server 10. If the advertising terminal 30 has received target members identification information from the POS server 10 and has stored it therein, the advertising terminal 30 can directly determine whether the member belongs to the target group to which the coupon service can be provided.

Also, a member can be authenticated according to whether the advertising terminal 30 can communicate with his or her portable terminal 50. This corresponds to a case where the portable terminal 50 communicates with the advertising terminal 30 only when a smart chip assigned only to members is stored in the portable terminal 50. The smart chip may be included in a membership card. That is, a member can be authorized according to whether communication between his or her portable terminal 50 and the advertising terminal 30 is possible.

Meanwhile, the member sees the coupon service information through the advertising terminal 30 and gets his or her desired coupon. For example, the member gets his or her desired coupon by inputting any one of keys that are included in the advertising terminal 30. The coupon is not an actual coupon but a virtual coupon.

If the member wants to get a coupon, the advertising terminal 30 transmits the member's identification information to the POS server 10. However, if the member identification information has been already transmitted to the POS server 10 when member certification has been performed, the advertising terminal 30 has only to inform the POS server 10 of a fact that the coupon has been issued.

The information acquiring unit 100 of the POS server 10 acquires the member identification information transmitted from the advertising terminal 30, and the coupon information virtually issued to the member. Also, the information registering unit 200 maps the member identification information to the coupon information, and registers the results of the mapping. The member identification information and the coupon information that are mapped to each other are stored in the information database 720.

Meanwhile, the POS server 10 provides all information stored in the information database 720 to each POS terminal 20, or provides some of the information stored in the information database 720 to each POS terminal 20. If the POS server 10 provides all information stored in the information database 720 to each POS terminal 20, the POS terminal 20 searches for its own information database 720 and provides a coupon service. If the POS server 10 provides some of the information stored in the information database 720 to each POS terminal 20, the POS terminal 20 requests the POS server 10 to confirm the coupon information and member identification information, and provides a coupon service in response to the confirmation result of the POS server 10.

The POS terminal 20 performs a product purchasing process and the coupon service process according to the present invention. The POS terminal 20 receives barcode information of a product, which is scanned by a scanner (not shown), and receives identification information of a member from a near field communication module (not shown). The near field communication module may be an RFID reader.

The coupon service providing unit 300 of the POS terminal 20 determines whether the member belongs to a target group to which a coupon service can be provided, and provides a coupon service to the member according to the determination result. A method of providing a coupon service has been described above, and accordingly, a detailed description thereof will be omitted.

FIG. 5 illustrates an example where the virtual coupon service system illustrated in

FIG. 3 is executed. Referring to FIGS. 3 and 5, a POS server 10 communicates with a plurality of POS terminals 20, for example, according to the RS-232C standard. As well-known in the art, a POS system includes a POS server and POS terminals. Since the structure of such a POS system is well-known in the art, a detailed description thereof will be omitted.

Also, the POS server 10 may communicate with a coupon service server 40 through an external network. The coupon service server 40 provides information required for a coupon service to the POS server 10.

A location server 60 detects the locations of members belonging to a target group to which the coupon service can be provided, and provides the location information of the members to the coupon service server 40. For example, the location server 60 detects the locations of members using a GPS.

Hereinafter, a virtual coupon service according to an embodiment of the present invention will be described in detail.

A system manager sets event information in the coupon service server 40. The event information is information required to provide a coupon service regarding purchasing of products. For example, the event information includes coupon service information, coupon information, information regarding a region in which the coupon service is provided, information regarding stores designated in a region, target member information, information indicating whether target members are located in a service available region, etc.

The target members information can be created by classifying members according to their genders, ages, purchase histories, etc. Also, the target members information can be created by classifying members' grades according to their purchase histories, etc. and limiting the coupon service according to the members' grades. Accordingly, the coupon service information and the coupon information will be classified according to the members' grades. Also, it is possible to limit the coupon service according to date and time. The information indicating whether target members are located in a service available region, etc. is used to determine whether a target member is within a predetermined range from a designated store.

The coupon service server 40 transmits the target members information to the location server 60. For example, the target members information transmitted to the location server 60 becomes member identification information. The location server 60 detects the location of a member with reference to the target members identification information, and transmits the location information of the member to the coupon service server 40. Then, a location detecting unit 400 receives the location information of the member from the location server 60, and detects the location of the member.

The coupon service information providing unit 500 determines whether the location of the member satisfies a predetermined condition. The predetermined condition may be ‘within a predetermined range from a designated store which is set in event information’. If the location of the member is within the predetermined range from the designated store, the coupon service information providing unit 500 provides the coupon service information to the member's portable terminal 50. Since a method of providing coupon service information to a portable terminal has been described above, a detailed description thereof will be omitted.

Accordingly, the member can acquire the coupon service information through his or her portable terminal 50, and can get a coupon when he or she requests the coupon. The coupon is not an actual coupon but a virtual coupon.

If the coupon service information is provided and the coupon is requested from the portable terminal 50, an information transfer unit 600 transfers coupon information corresponding to the member and identification information of the member to a POS server 10 of the designated store, with reference to the event information. Accordingly, the POS server 10 receives the coupon information and the member identification information.

The information acquiring unit 100 of the POS server 10 also acquires the coupon information and the member identification information. Also, the information registering unit 200 registers the member identification information and the coupon information. Then, the target member identification information and the coupon information are stored in the information database 720.

Meanwhile, the POS server 10 provides all information stored in the information database 720 to each POS terminal 20, or provides some of the information stored in the information database 720 to each POS terminal 20. If the POS server 10 provides all information stored in the information database 720 to each POS terminal 20, the POS terminal 20 searches for its own information database 720 and provides a coupon service. If the POS server 10 provides some of the information stored in the information database 720 to each POS terminal 20, the POS terminal 20 requests the POS server 10 to confirm the coupon information and the member identification information, and provides the coupon service according to the confirmation result.

The POS terminal 20 performs a product purchasing process and the coupon service process. The POS terminal 20 receives barcode information of a product, which is scanned by a scanner (not shown), and receives member identification information from a near field communication module (not shown). The near field communication module may be an RFID reader.

The coupon service providing unit 300 of the POS terminal 20 determines whether the member belongs to a target group to which the coupon service can be provided, and provides a coupon service according to the determination result. Since a method of providing a coupon service has been described above, a detailed description thereof will be omitted.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The virtual coupon service system according to the present invention can be applied to various Internet services, marketing for sales promotion, client management, etc.

1. A virtual coupon service system comprising:
an information acquiring unit acquiring member identification information of a member who wants to purchase a product for which the coupon is valid, and coupon information regarding the product;
an information registering unit mapping the member identification information to the coupon information, and registering the result of the mapping;
a coupon service providing unit acquiring the member identification information and a product code of the product, determining whether the member identification information is registered with the information registering unit, determining whether at least one coupon information mapped to the member identification information is associated with the product code, if the member identification information is registered with the information registering unit, providing the coupon service if the at least one coupon information includes the product code.

2. The virtual coupon service system of claim 1, wherein the coupon service comprises getting a discount for the product or accumulating a mileage.

3. The virtual coupon service system of claim 1, further comprising at least one advertising terminal providing coupon service information in image and/or voice, receiving the member identification information and outputting the member identification information to the information acquiring unit.

4. The virtual coupon service system of claim 3, wherein the advertising terminal detects whether a member accesses the advertising terminal, and providing the coupon service information to the member.

5. The virtual coupon service system of claim 1, further comprising:
a location detecting unit detecting a location of the member;
a coupon service information providing unit providing coupon service information regarding purchasing of the product to a portable terminal of the member if the location of the member satisfies a predetermined condition; and
an information transfer unit transferring the member identification information and the coupon information to the information acquiring unit, if the member requests the coupon through the portable terminal with reference to the coupon service information.

6. The virtual coupon service system of claim 5, wherein the predetermined condition is set to within a predetermined range from a designated store.

7. The virtual coupon service system of claim 5, wherein the coupon information comprises at least one of location of member, date/time, and grade of member.

8. A virtual coupon service system comprising:
a location information acquiring unit acquiring member location information of a member;
a coupon service information providing unit providing to a portable terminal of the member coupon service information regarding purchasing of a product for which the coupon is valid, if a location of the member included in the member location information satisfies a predetermined condition; and
an information transfer unit transferring the member identification information and coupon information to a Point-of-Sale (POS) server of a designated store, if the member requests the coupon service through the portable terminal with reference to the coupon service information.

9. The virtual coupon service system of claim 8, wherein the predetermined condition is set to within a predetermined range from a designated store.

10. The virtual coupon service system of claim 8, wherein the coupon information includes at least one of locations of members, dates/times, and grade of member.

11. The virtual coupon service system of any one of claims 8, 9, and 10, wherein the coupon information comprises information regarding the product for which the coupon is valid, a discount rate, or a mileage.
